(19) United States
(12) Patent Application Publication
(10) Pub. No.: US 2025/0219538 A1
(43) Pub. Date: Jul. 3, 2025

(54) VOLTAGE REGULATOR CIRCUIT, SEMICONDUCTOR DEVICE INCLUDING THE SAME, AND OPERATING METHOD OF THE SAME

(71) Applicant: SAMSUNG ELECTRONICS CO., LTD., SUWON-SI (KR)

(72) Inventors: TAKAHIRO NOMIYAMA, SUWON-SI (KR); DONGHOON JUNG, SUWON-SI (KR)

(21) Appl. No.: 18/969,572

(22) Filed: Dec. 5, 2024

(30) Foreign Application Priority Data
Dec. 29, 2023 (KR) 10-2023-0197338
Apr. 3, 2024 (KR) 10-2024-0045442

(51) Int. Cl. H02M 3/158; H02M 1/00; H02M 1/08; H02M 1/32

(52) U.S. Cl. CPC H02M 3/158; H02M 1/08; H02M 1/32; H02M 1/0054

(57) ABSTRACT

Disclosed is a semiconductor device, which includes a semiconductor integrated circuit (IC) chip including a load circuit which receives a load current from an integrated voltage regulator (IVR), and a substrate including an electrical path for providing a signal to the semiconductor IC chip, and the IVR includes a capacitor including one end connected to an output node and the other end connected to a ground, an inductor connecting the output node to an input node, and a first switch, a second switch, and a third switch, one end of each switch respectively connected to the input node, and the first switch, the second switch, and the third switch alternately provide a first input voltage, a second input voltage, and a ground voltage to the input node, respectively.

### CROSS-REFERENCE TO RELATED APPLICATIONS

This U.S. non-provisional patent application claims priority under 35 U.S.C. § 119 to Korean Patent Application Nos. 10-2023-0197338 filed on Dec. 29, 2023, and 10-2024-0045442 filed on Apr. 3, 2024, respectively, in the Korean Intellectual Property Office (KIPO), the disclosures of which are incorporated by reference herein in their entireties.

### FIELD

The present disclosure generally relates to semiconductor devices, and more particularly relates to voltage regulating circuits for semiconductor devices and operating methods thereof.

### INTRODUCTION

Many components may be included in modern semiconductor devices. For example, the number of processor cores is increasing, as is the number of additional computational logic units, such as memory controllers and hardware accelerators included in the same semiconductor device as the core.

Moreover, it may be desirable in some applications to further reduce power consumption. As a way to decrease the energy consumption of semiconductor devices such as a system-on-chip (SoC), an Integrated Voltage Regulator (IVR) technology implementing an on-chip voltage domain may be applied. To use a buck converter in the IVR, the energy efficiency of the buck converter may be increased over that of a basic buck converter. For example, a method of maintaining an inductor ripple current or Inductor Peak-to-Peak current (IPP) in a low range may be used. To achieve low IPP in the buck converter, the inductance of the buck converter may be increased and/or the switching frequency may be increased. However, an increase in inductance might include an increase in the number of inductors or an occupied area of the buck converter, and an increase in the switching frequency may reduce the energy efficiency of the buck converter at light load conditions due to switching losses. In addition, a three level buck converter (TLBK) may be used in the IVR, but the TLBK might include additional large-capacitance passive elements such as a flying capacitor, and might exhibit low energy efficiency at a heavy load condition due to the resistive component of the flying capacitor.

### SUMMARY

Embodiments of the present disclosure may provide an integrated voltage regulator (IVR) that has a small area and high energy efficiency, a semiconductor device including the integrated voltage regulator, and/or an operating method thereof.

According to an embodiment of the present disclosure, a semiconductor device includes a voltage regulator, a semiconductor integrated circuit (IC) chip including a load circuit configured to receive a load current from the voltage regulator, and a substrate including an electrical path configured to provide a signal to at least one of the voltage regulator or the semiconductor IC chip, and the voltage regulator includes a capacitor including one end connected to an output node and the other end connected to a ground, an inductor connecting the output node to an input node, and a first switch, a second switch, and a third switch, one end of each switch respectively connected to the input node, and the first switch, the second switch, and the third switch alternately provide a first input voltage, a second input voltage, and a ground voltage to the input node, respectively.

According to an embodiment of the present disclosure, an electronic device includes a power management device including a first voltage regulator that receives a battery voltage and generates a first input voltage which is regulated and a second voltage regulator that receives the battery voltage and generates a second input voltage which is regulated, and a system-on-chip (SOC) including an integrated voltage regulator (IVR) that generates a load current based on the first input voltage and the second input voltage, and a load circuit that receives the load current through an output node, and the IVR includes a plurality of switches that alternately provides the first input voltage, the second input voltage, and a ground voltage to an inductor, the inductor that alternately receives the first input voltage, the second input voltage, and the ground voltage, and provides the load current to the output node, and a capacitor that connects the output node to a ground.

According to an embodiment of the present disclosure, a voltage regulator circuit includes an input node that alternately provides a first input voltage, a second input voltage, and a ground voltage to an inductor, a plurality of switches connected to the input node and that provide one of the first input voltage, the second input voltage, and the ground voltage to the input node, the inductor including one end connected to the input node and the other end connected to an output node, and a capacitor including one end connected to the output node and the other end connected to a ground, and the input node receives the first input voltage and the second input voltage from outside of the voltage regulator circuit.

According to an embodiment of the present disclosure, a method of operating a voltage regulator circuit includes providing a first input voltage received from outside of the voltage regulator to an inductor by turning on a first switch inside the voltage regulator, providing a second input voltage, which has a different level from the first input voltage and is received from outside of the voltage regulator, to the inductor by turning on a second switch inside the voltage regulator, providing a ground voltage to the inductor by turning on a third switch inside the voltage regulator, and providing, by the inductor, a load current to a load circuit through an output node, and the output node is connected to a ground through a capacitor.

### BRIEF DESCRIPTION OF THE DRAWINGS

The above and other applications of the present disclosure will become apparent by describing in detail embodiments thereof with reference to the accompanying drawings.

FIG. 1 is a hybrid circuit diagram illustrating an electronic device including a semiconductor device as an example, according to an embodiment of the present disclosure.

FIG. 2 is a block diagram illustrating a semiconductor device as an example, according to an embodiment of the present disclosure.

FIG. 3 is a cross-sectional view diagram of a semiconductor device as an example, according to an embodiment of the present disclosure.

FIG. 4A is a simplified circuit diagram of a low-switching-frequency enhanced 3-level buck converter (ETLBK), and FIG. 4B is a graphical diagram for an operation of the ETLBK.

FIG. 5 is a hybrid circuit diagram of an integrated voltage regulator (IVR) and external voltage regulators, which are included in an electronic device, according to an embodiment of the present disclosure.

FIGS. 6A and 6B are graphical diagrams for operations of the IVR of FIG. 5, according to an embodiment of the present disclosure.

FIG. 7 is a graphical diagram comparing energy efficiencies of an IVR, according to an embodiment of the present disclosure under various loads, versus those of a buck converter.

FIG. 8 is a hybrid circuit diagram of an IVR), as well as external voltage regulators, which are included in an electronic device, according to an embodiment of the present disclosure.

FIG. 9 is a hybrid circuit diagram illustrating an operation of a voltage regulator at a heavy load, according to the embodiment of FIG. 8.

FIG. 10 is a graphical diagram for the operation of the voltage regulator at heavy load of FIG. 9, according to the embodiment of FIG. 8.

FIG. 11 is a hybrid circuit diagram of an IVR, as well as external voltage regulators, which are included in an electronic device, according to an embodiment of the present disclosure.

FIG. 12 is a cross-sectional view diagram illustrating an example of a semiconductor device, according to an embodiment of the present disclosure.

FIG. 13 is a cross-sectional view diagram illustrating an example of a semiconductor device, according to an embodiment of the present disclosure.

FIG. 14 is a flowchart diagram describing a method of operating an IVR, according to an embodiment of the present disclosure.

### DETAILED DESCRIPTION

Hereinafter, embodiments of the present disclosure will be described in detail such that one of ordinary skill in the pertinent art may readily practice the claimed invention.

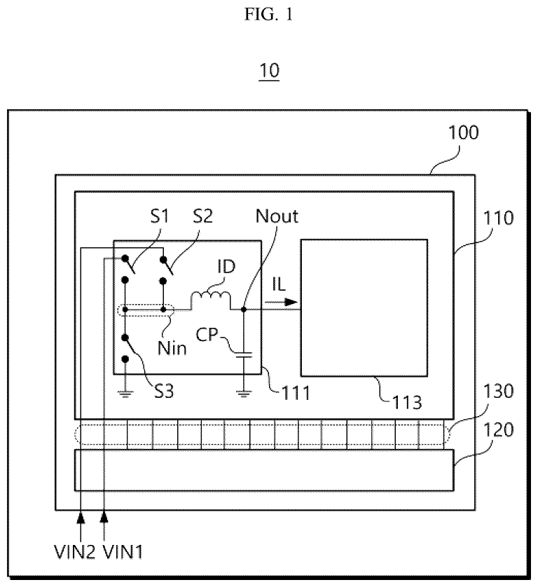

FIG. 1 shows an electronic device 10 as an example, according to an embodiment of the present disclosure. FIG. 1 illustrates the electronic device 10 including a voltage regulator 111, according to an embodiment of the present disclosure.

The electronic device 10 according to an embodiment of the present disclosure may be one of various types of electronic devices such as a desktop computer, tablet computer, laptop computer, smart phone, wearable device, digital camera, display device, workstation, server, electric vehicle, home appliance, television, set-top box, medical device, or the like.

According to an embodiment, the electronic device 10 may further include other general-purpose components in addition to a semiconductor device 100, as illustrated in FIG. 1. For example, the electronic device 10 may further include a volatile memory, a non-volatile memory, a user interface, and/or a display panel.

The semiconductor device 100 may include at least one semiconductor integrated circuit (IC) chip 110 that is mounted on a packaging substrate 120 and packaged. The semiconductor device 100 may be, for example, a system-on-chip (SoC), an application specific integrated circuit (ASIC), a field programmable gate array (FPGA), a processor, or the like.

The semiconductor IC chip 110, through electrical paths 130 and the packaging substrate 120, may exchange signals with an external device or may receive voltages from the outside. For example, the semiconductor IC chip 110 may receive a battery voltage provided from a battery through the packaging substrate 120 and the electrical paths 130. According to an embodiment, the semiconductor IC chip 110 may receive an input voltage, having a level converted from a level of the battery voltage by a voltage regulator external to the semiconductor IC chip 110, through the packaging substrate 120 and the electrical paths 130.

The semiconductor integrated circuit (IC) chip 110 may include a load circuit 113 and the voltage regulator 111, which may be integrated within the IC 110 and referred to as an integrated voltage regulator (IVR).

The load circuit 113 may be a logic circuit, a memory device, a radio frequency (RF) circuit, or the like. The logic circuit may be a processing core, a graphics processing unit (GPU), a neural processing unit (NPU), a digital signal processor (DSP), an image signal processor (ISP), an artificial intelligence (AI) accelerator, a controller, or the like. According to an embodiment, there may be a plurality of load circuits 113. For example, a plurality of processing cores may be formed in the semiconductor IC chip 110. Additionally, a processing core and a GPU may be formed in the semiconductor IC chip 110. The load circuit 113 may be any one of a variety of electrical circuits and is not limited to the above examples.

The IVR 111 may convert the level of at least one input voltage provided from outside of the semiconductor IC chip 110. In greater detail, the IVR 111 may convert the level of the input voltage to generate an output voltage and may provide a load current IL based on the output voltage to the load circuit 113. The load circuit 113 may operate the circuit using the provided load current IL. According to an embodiment, in response to a plurality of load circuits 110, a plurality of IVRs 111 may generate a plurality of output voltages, respectively, and may provide the output voltage to at least some of the plurality of load circuits 110. At least some of the plurality of output voltages may have different levels.

The IVR 111 according to an embodiment of the present disclosure may receive two input voltages VIN1 and VIN2 from outside of the semiconductor IC chip 110, may generate an output voltage based on alternately switching between the two input voltages VIN1 and VIN2 and a ground voltage, and may provide the load current IL based on the output voltage to the load circuit 113.

Switches S1, S2, and S3 may be turned on complementary to each other in a duty cycle. For example, in a time interval in which one of the switches S1, S2, and S3 is turned on, the remaining switches may be turned off. An input node Nin may be located between the switches S1, S2, and S3. One end of each of the switches S1, S2, and S3 may be connected to the input node

Nin. In greater detail, each of the switches S1, S2, and S3 may be electrically coupled to the input node Nin. Other ends of the switches S1, S2, and S3 may be connected to the first input voltage VIN1, the second input voltage VIN2, and the ground voltage, respectively. The switches S1, S2, and S3 may alternately provide one of the first input voltage VIN1, the second input voltage VIN2, or the ground voltage, respectively, to the input node Nin under a control of a switch driving signal. The input node Nin is coupled to an inductor ID and therefore, an embodiment of the present disclosure may be a type of 3-level buck converter, without limitation thereto. For example, the buck converter may be a step-down converter.

The inductor ID may connect the input node Nin to an output node Nout. The output node Nout may be connected to the load circuit 113 and to a capacitor CP. The inductor ID and the capacitor CP may operate as an LC filter.

The inductor ID may operate in three steps within a duty cycle. When the first switch S1 is turned on and the other switches S2 and S3 are turned off, the inductor ID may be charged and the load current IL may be provided to the load circuit 113 connected to the output node Nout. When the third switch S3 is turned on and the other switches S1 and S2 are turned off, the inductor ID may be discharged to provide the load current IL to the output node Nout. When the second switch S2 is turned on and the other switches S1 and

S3 are turned off, the inductor ID may be charged or discharged depending on the setting of the second input voltage VIN2. According to these operations of the inductor ID, the output voltage provided to the output node Nout may have a waveform with a duty cycle, and the waveform of the load current IL provided to the load circuit 113 by the output voltage may include three phases. Based on this, the switching frequency of the IVR 111 may be lower than that of a basic buck converter (BK). In a light load environment of the load circuit 113, energy loss due to switching of the voltage regulator is one of the major causes of energy loss. Therefore, reducing the switching frequency of the IVR 111 according to an embodiment of the present disclosure may improve energy efficiency in a light load environment of the load circuit 113. The energy efficiency may be based on regulator or converter efficiency. Additionally, to reduce the switching frequency, an inductor peak-to-peak current (IPP) or the inductor ripple current may be maintained in a low range without including separate passive elements and without increasing the inductance. As a result, the IVR 111 may exhibit high efficiency at light loads due to low switching frequency discussed in greater detail supra; exhibit high efficiency at heavy loads due to reduced flow through passive components such as switching out, reducing and/or omitting a flying capacitor, which may be discussed in greater detail infra; and maintain a small footprint area or volume which may be advantageous for integration into the semiconductor IC chip 110.

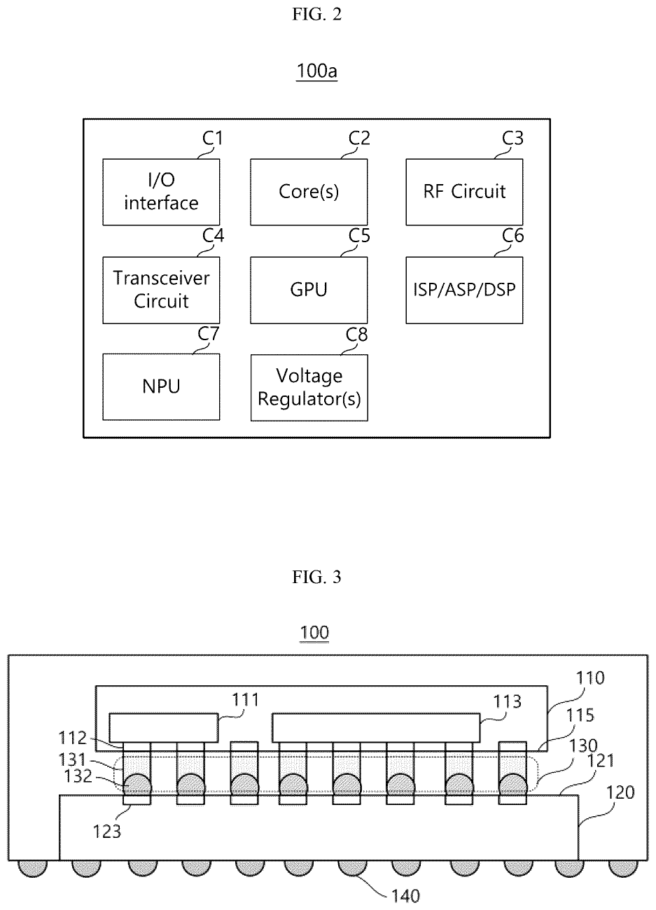

FIG. 2 shows a semiconductor device as an example, according to an embodiment of the present disclosure. A semiconductor device 100a according to the embodiment of FIG. 2 may correspond to the semiconductor device 100 of FIG. 1.

The semiconductor device 100a may include at least one functional block. The functional block may be a controller, an arithmetic logic unit (ALU), a memory, or the like. Alternatively, the functional block may be a circuit designed to perform a specific function. For example, the functional block may be any one of a central processing unit (CPU), a control circuit, an artificial intelligence calculation processing unit (AICPU), a graphics processing unit (GPU), a communications unit, a signal processing unit, or a media processing unit (MPU). For example, referring to FIG. 2, the control circuit may include an input/output (I/O) interface C1. The central processing unit may include at least one core C2. The communications unit may include an RF circuit C3 and a transceiver circuit C4. The functional block may include a GPU C5. The signal processing unit may include the ISP, an audio signal processor (ASP), and a digital signal processor (DSP) C6. The Al calculation processing unit may include a numeric processing unit (NPU) C7. The semiconductor device 100a may include general-purpose or special-purpose functional blocks other than the functional blocks mentioned in this specification. The semiconductor device 100a may include at least one voltage regulator C8 that provides the load current to at least one of the functional blocks.

FIG. 3 shows a semiconductor device as an example, according to an embodiment of the present disclosure. The semiconductor device of FIG. 3 may correspond to the semiconductor device 100 of FIG. 1.

The semiconductor device 100 may be configured with the semiconductor IC chip 110 connected to the substrate 120 through electrical paths 130, and packaged. The substrate 120 may be a packaging substrate.

The semiconductor device 100 may be electrically connected to an external device through an external contact 140 located outside the packaging. The external contact 140 may be one of various types of conductive contact and connection structures such as a Ball Grid Array (BGA), a Pin Grid Array (PGA), and/or a Land Grid Array (LGA).

The substrate 120 may be connected to the electrical paths 130 through conductive contacts 123 located near a first surface 121. In an embodiment, additional electrical paths such as metal layers may be formed inside the substrate 120.

The electrical paths 130 may be conductive structures for electrically connecting the semiconductor IC chip 110 and the substrate 120 to each other. For example, the electrical paths 130 may each include a conductive pillar 131 and a conductive contact 132. The conductive pillar 131 may be, for example, a copper pillar, and the conductive contact 132 may be, for example, a micro bump, a bump, or the like. The electrical paths 130 are not limited thereto and may include various conductive structures. Although FIG. 3 illustrates that the substrate 120 and the semiconductor IC chip 110 are directly connected through the electrical paths 130, the present disclosure is not limited thereto. For example, the substrate 120 and the semiconductor IC chip 110 may be electrically connected to each other through an interposer located therebetween. Additionally, although FIG. 3 illustrates the substrate 120 and one semiconductor IC chip 110 packaged together, the semiconductor device 100 may further include a plurality of semiconductor IC chips. The plurality of semiconductor IC chips may be electrically connected to each other through an interposer and/or the substrate 120, or may be stacked in a direction perpendicular to the first surface 121 of the substrate 120.

The semiconductor IC chip 110 may include functional blocks such as the IVR 111 and the load circuit 113 formed in an active area of a top surface 115. The IVR 111 and the load circuit 113 may receive an external voltage or may exchange electrical signals through conductive contacts 112 connected to the electrical paths 130. Inside the semiconductor IC chip 110, electrical paths such as a metal layer and a through silicon via (TSV) may be formed.

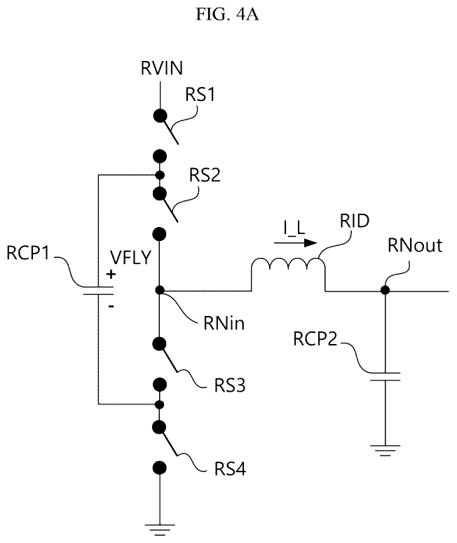

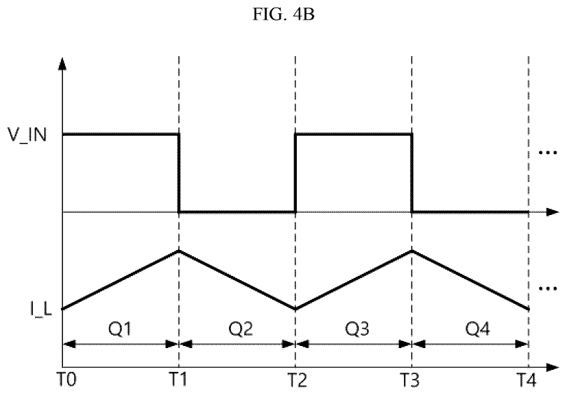

FIG. 4A shows a low-frequency 3-level buck converter (LF3LBK), and FIG. 4B shows operation of the ETLBK of FIG. 4A.

Referring to FIG. 4A, the ETLBK has a structure in which a switched flying capacitor RCP1 and two additional switches RS2 and RS3 are added, in addition to the elements of a basic buck converter including switches RS1 and RS4 and a switched inductor RID. Switches RS1, RS2, RS3, and RS4 may each be a Field Effect Transistor (FET) or a Metal Oxide Semiconductor FET (MOSFET), without limitation thereto.

The ETLBK drives the external switches RS1 and RS4 similarly to a basic buck converter. Moreover, a phase of the signal controlling the internal switch RS2 is shifted by about 180 degrees from that of the signal controlling the external switch RS1. Additionally, the signal controlling the internal switch RS3 is phase shifted by about 180 degrees from the signal controlling the external switch RS4. By keeping a voltage of the flying capacitor RCP1 close to half an input voltage RVIN, a voltage of an input node RNin alternates between the input voltage RVIN, the input voltage RVIN/2, and the ground voltage. Therefore, it may be called a “low frequency 3-level” buck converter (LF3LBK).

FIG. 4B illustrates a switching cycle when a duty cycle “D” of the low-frequency 3-level buck converter of FIG. 4A is less than a value of 0.5, such as when the input voltage RVIN is more than twice the output voltage of an output node RNout. When the duty cycle D=0.5 (e.g., 50%), the switch RS1 and the switch RS3 are turned on for half of the switching cycle interval, and the switch RS2 and the switch RS4 are turned on for the other half interval. Accordingly, the output voltage of the output node RNout is maintained at the input voltage RVIN/2.

When compared to a basic buck converter with similar physical characteristics under the same driving conditions, a ETLBK may have a lower switching frequency under the same IPP conditions. Therefore, the ETLBK of FIG. 4A may improve energy efficiency in a light load environment compared to the basic buck converter or a high-frequency three level buck converter. However, to this end, the ETLBK of FIG. 4A may use the flying capacitor RCP1.

The flying capacitor RCP1 includes a capacitor equivalent series resistance (ESR), and the ESR may cause additional loss in a heavy load environment of the load circuit. Therefore, the ETLBK structure of FIG. 4A is suitable for the light load conditions, but may be difficult to use in environments that require high maximum current. Additionally, the ETLBK of FIG. 4A may use additional occupied area due to the flying capacitor RCP1, which is a passive element. In particular, when implementing a multiphase parallel converter using the ETLBK of FIG. 4A, the semiconductor device might sacrifice a relatively large area of space due to multiple flying capacitors RCP1. This may not comport with the developmental trend of semiconductor devices. Therefore, despite improved light load efficiency, it may be difficult to justify using the ETLBK of FIG. 4A alone as the IVR in some semiconductor devices.

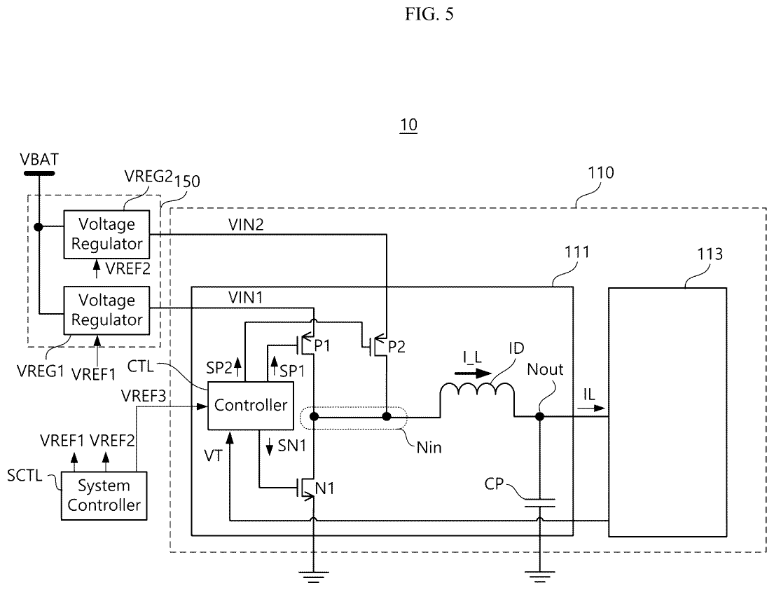

FIG. 5 shows an IVR and external voltage regulators, which are included in an electronic device, according to an embodiment of the present disclosure. The electronic device 10 may correspond to the electronic device 10 of FIG. 1. Additional description of parts that overlap or are similar to the description referring to FIG. 1 may be omitted to avoid redundancy. The electronic device 10 according to an embodiment of the

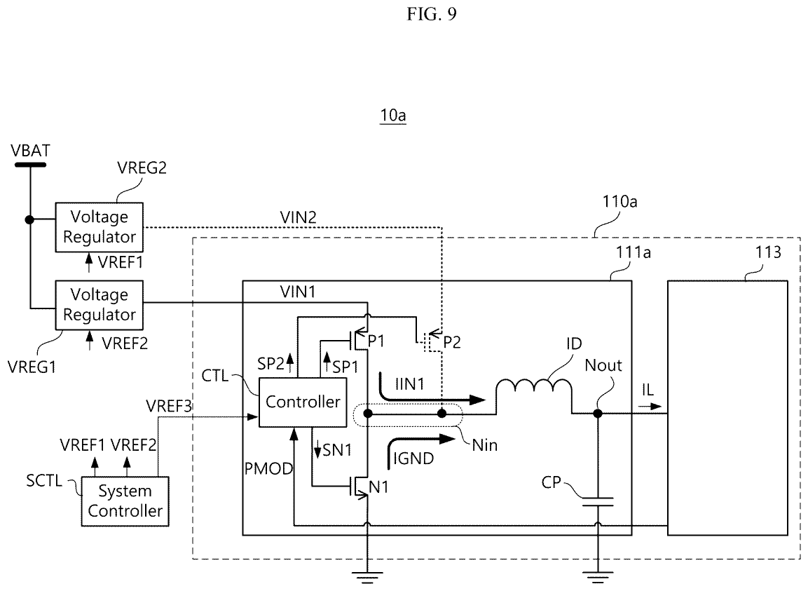

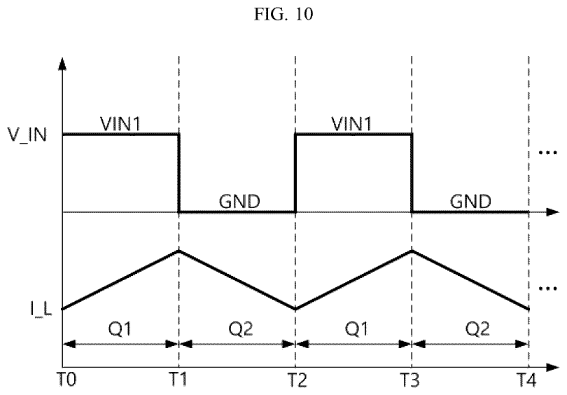

present disclosure may include the semiconductor device 110 and a plurality of voltage regulators VREG1 and VREG2 located outside of the semiconductor device 110. The plurality of voltage regulators VREG1 and VREG2 may receive reference voltages VREF1 and VREF2, respectively. The plurality of voltage regulators VREG1 and VREG2 may be implemented as a power management device, such as a Power Management IC (PMIC). The plurality of voltage regulators VREG1 and VREG2 may convert the received battery voltage VBAT based on the reference voltages VREF1 and VREF2, respectively, and may generate the input voltages VIN1 and VIN2, respectively, which are provided to the IVR 111. The plurality of voltage regulators VREG1 and VREG2 may compare the reference voltages VREF1 and VREF2 with the input voltages VIN1 and VIN2, respectively, and may control the input voltages VIN1 and VIN2 using a pulse-width modulation (PWM) or a pulse-frequency modulation (PFM), based on the difference of the comparison. The reference voltages VREF1 and VREF2 may be provided from a system controller SCTL. In an embodiment, the plurality of voltage regulators VREG1 and VREG2 may be any one of a buck converter, a 3-level buck converter, and a low dropout (LDO) regulator. In an embodiment, when the plurality of voltage regulators VREG1 and VREG2 are the buck converters, the circuit may be similar to the IVR 111 except for a second transistor P2. The plurality of voltage regulators VREG1 and VREG2 may be similar to those of the circuit of FIG. 9, described infra. In greater detail, the plurality of voltage regulators VREG1 and VREG2 may include a first switch connecting an input voltage to an input node, a second switch connecting an input node to the ground voltage, like a basic buck converter, and may include an inductor connecting an input node to output node and a capacitor connected in parallel with the inductor to the output node. The inductor of each of the plurality of voltage regulators VREG1 and VREG2 may alternately operate in a charging step and a discharging step similar to FIG. 10, described infra.

The semiconductor device 110 may include the IVR 111 according to an embodiment of the present disclosure and the load circuit 113 which receives the load current IL from the IVR 111.

The IVR 111 may generate an output voltage based on the input voltages VIN1 and VIN2 provided from the plurality of voltage regulators VREG1 and VREG2, and may provide the load current IL based on the output voltage to the load circuit 113 through the output node Nout.

The IVR 111 may receive the two input voltages VIN1 and VIN2 from outside of the semiconductor IC chip 110 through a first transistor P1 and the second transistor P2, respectively.

One end of each of the first transistor P1, the second transistor P2, and a third transistor N1 may be connected to the input node Nin. The other end of the first transistor P1 may be connected to the first voltage regulator VREG1 and may receive the first input voltage VIN1. The other end of the second transistor P2 may be connected to the second voltage regulator VREG2 and may receive the second input voltage VIN2. The other end of the third transistor N1 may be connected to the ground and may receive the ground voltage.

The first transistor P1, the second transistor P2, and the third transistor N1 may be power transistors that function as switches. In an embodiment, the first transistor P1 and the second transistor P2 may be P type MOSFETs, and the third transistor N1 may be an N type MOSFET, without limitation thereto.

The IVR 111 may control the first transistor P1, the second transistor P2, and the third transistor N1, based on control signals SP1, SP2, and SN1 provided from a controller CTL, respectively. The IVR 111 may turn on or turn off the first transistor P1, the second transistor P2, and the third transistor N1, based on the control signals SP1, SP2, and SN1, respectively, such that the input voltages VIN1 and VIN2 and the ground voltage are alternately provided to the inductor ID.

The control signals SP1, SP2, and SN1 may be signals which control the first transistor P1, the second transistor P2, and the third transistor N1, respectively, such that the first transistor P1, the second transistor P2, and the third transistor N1 are turned on in a complementary manner. Each of the control signals SP1, SP2, and SN1 may have a high level complementary to each other in the duty cycles of the first transistor P1, the second transistor P2, and the third transistor N1. For example, in a time interval in which one of the first transistor P1, the second transistor P2, and the third transistor N1 is turned on, the other two transistors may be turned off.

The controller CTL may generate the control signals SP1, SP2, and SN1 based on a target voltage VT provided from the load circuit 113. For example, the controller CTL may generate the control signals SP1, SP2, and SN1 such that the output voltage corresponding to the target voltage VT is generated by controlling the time interval in which the first transistor P1, the second transistor P2, and the third transistor N1 are each turned on.

The input node Nin is coupled to the inductor ID, and the inductor ID may connect the input node Nin to the output node Nout. The output node Nout may be connected to the load circuit 113 and the capacitor CP. The inductor ID and the capacitor CP may operate as an LC filter.

The IVR 111 may operate as the ETLBK by using the voltage regulator external to the semiconductor IC chip 110 without the flying capacitor. Additionally, the IVR 111 may reduce the switching frequency and may increase energy efficiency in a small area by adding an operation step of the inductor ID based on the second input voltage VIN2.

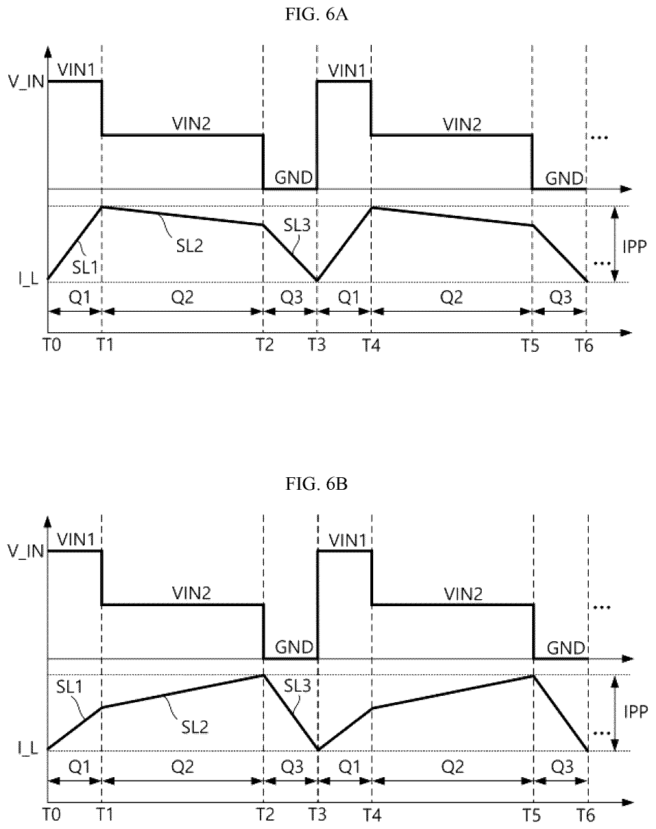

FIGS. 6A and 6B show operation of the IVR 111 of FIG. 5, according to an embodiment of the present disclosure. The operation of the IVR 111 will be described with reference to FIGS. 5, 6A, and 6B.

FIGS. 6A and 6B illustrate changes in an input voltage V_IN provided to the input node Nin according to the operation of the IVR 111, and changes in an inductor current I_L flowing through the inductor ID due to changes in the input voltage V_IN.

Referring to FIGS. 6A and 6B, the first transistor P1, the second transistor P2, and the third transistor N1 in the IVR 111 may be sequentially turned on in different time intervals. For example, referring to FIGS. 6A and 6B, in a Q1 step between times T0 and T1, only the first transistor P1 may be turned on, and the second transistor P2 and the third transistor N1 may be turned off. After the Q1 step, in a Q2 step between times T1 and T2, only the second transistor P2 may be turned on, and the first transistor P1 and the third transistor

N1 may be turned off. After the Q2 step, in a Q3 step between times T2 and T3, only the third transistor N1 may be turned on, and the first transistor P1 and the second transistor P2 may be turned off. Thereafter, the IVR 111 may operate to repeat the steps Q1, Q2, and Q3. In greater detail, the Q1 step, the Q2 step, and the Q3 step form one period. Therefore, unlike related arts, the switching frequency of the IVR 111 may be lowered due to the addition of the Q2 step to form one period.

In an embodiment, the controller CTL may control the first transistor P1, the second transistor P2, and the third transistor N1 such that the durations of the Q1 step, the Q2 step, and the Q3 step are different, based on the target voltage VT.

In an embodiment, the duration of the Q2 step may be longer than the durations of the Q1 step and/or the Q3 step. That is, the time interval between times T1 and T2 may be longer than the time interval between times T0 and T1 and/or the time interval between times T2 and T3. Accordingly, the rate of change for the inductor current I_L corresponding to the Q2 step may be lower than the rates of change for the inductor current I_L corresponding to the Q1 step and/or the Q3 step.

Referring to FIG. 5, in the Q1 step, the Q2 step, and the Q3 step, the inductor current I_L is based on an input voltage VIN of the input node Nin and an output voltage VOUT provided to the output node Nout. In greater detail, in the Q1 step, a slope SL1 according to the change in the inductor current I_L is a ratio of the difference VIN1-VOUT between the first input voltage VIN1 and the output voltage VOUT with respect to the inductance of the inductor ID. In the Q2 step, a slope SL2 according to the change in the inductor current I_L is a ratio of the difference VIN2-VOUT between the second input voltage VIN2 and the output voltage VOUT with respect to the inductance of the inductor ID. In the Q3 step, a slope SL3 according to the change in the inductor current I_L is a ratio of the output voltage VOUT with respect to the inductance of the inductor ID. In an embodiment, the system controller SCTL may control the

second voltage regulator VREG2 such that the level of the second input voltage VIN2 is similar to the level of the output voltage VOUT. Therefore, the slope SL2 according to the change in the inductor current I_L in the Q2 step may be gentler than the slope SL1 according to the change in the inductor current I_L in the Q1 step and/or the slope SL3 according to the change in the inductor current I_L in the Q3 step. In addition, the controller CTL of the IVR 111 may control the switching frequency of the IVR 111 by controlling the duration of the Q2 step, that is, the length of the turn-on time interval of the second transistor P2. For example, the controller CTL may lower the switching frequency of the IVR 111 by increasing the length of the turn-on time interval of the second transistor P2. As a result, the energy efficiency of the IVR 111 may be increased. In greater detail, the system controller SCTL may control the second input voltage VIN2 such that the level of the second input voltage VIN2 is similar to the level of the output voltage VOUT, and the IVR 111 may control the duration of the Q2 step to decrease the switching frequency of the IVR 111, so that the energy efficiency of the IVR 111 may be increased. However, when the duration of the Q2 step is too long, an output ripple voltage may increase. In contrast, when the duration of the Q2 step is too short, the increase in energy efficiency may be minimal.

Accordingly, the controller CTL may determine the duration of the Q2 step depending on the purpose and performance of the load circuit.

In an embodiment, the first input voltage VIN1 provided to the input node Nin through the first transistor P1 may be greater than second input voltage VIN2 provided to the input node Nin through the second transistor P2.

The second input voltage VIN2 may be greater than, less than, or equal to the output voltage VOUT. The fact that the second input voltage VIN2 is the same as the output voltage VOUT may mean that the levels of the two are actually similar. Additionally, since the IVR 111 is a step-down converter, the first input voltage VIN1 may be greater than the output voltage VOUT. Therefore, even if the duration of the Q2 step is the same as the duration of the Q1 step, the slope SL2 due to the change in inductor current I_L in the Q2 step may be gentler than the slope SL1 due to the change in inductor current I_L in the Q1 step.

FIG. 6A illustrates an operation of the IVR 111 when the second input voltage VIN2 provided to the input node Nin through the second transistor P2 is less than the output voltage VOUT provided to the output node Nout. In a first charging step Q1, the controller CTL may output the first

control signal SP1 having a low level, the second control signal SP2 having a high level, and the third control signal SN1 having a low level. When the first control signal SP1 having a low level is provided to a gate node of the first transistor P1, the first transistor P1 is turned on, and the first input voltage VIN1 may be provided to the input node Nin. The second control signal SP2 which has a high level and the third control signal SN1 which has a low level are provided to gate nodes of the second transistor P2 and the third transistor N1, respectively, and the second transistor P2 and the third transistor N1 may be turned off. Therefore, as a result, only the first input voltage VIN1 may be provided to the input node Nin. The inductor ID may be charged by the first input voltage VIN1 provided from the input node Nin. In the first charging step Q1, the inductor current I_L may increase due to a change in the voltage of the inductor ID.

In a first discharging step Q2, the controller CTL may output the second control signal SP2 having a low level, the first control signal SP1 having a high level, and the third control signal SN1 having a low level. When the second control signal SP2 having a low level is provided to a gate node of the second transistor P2, the second transistor P2 is turned on, and the second input voltage VIN2 may be provided to the input node Nin. The first control signal SP1 which has a high level and the third control signal SN1 which has a low level are provided to gate nodes of the first transistor P1 and the third transistor N1, respectively, and the first transistor P1 and the third transistor N1 may be turned off. Therefore, as a result, only the second input voltage VIN2 may be provided to the input node Nin. Since the second input voltage VIN2 is lower than the output voltage VOUT, the inductor ID may be discharged by the second input voltage VIN2 provided from the input node Nin. Accordingly, in the first discharging step Q2, the inductor current I_L may decrease due to a change in the voltage of the inductor ID.

In a second discharging step Q3, the controller CTL may output the third control signal SN1 having a high level, the first control signal SP1 having a high level, and the second control signal SP2 having a high level. When the third control signal SN1 having a high level is provided to a gate node of the third transistor N1, the third transistor N1 is turned on and may provide the ground voltage to the input node Nin. The first control signal SP1 and the second control signal SP2 which have a high level are provided to gate nodes of the first transistor P1 and the second transistor P2, respectively, and the first transistor P1 and the second transistor P2 may be turned off. Therefore, as a result, only the ground voltage may be provided to the input node Nin. Since the ground voltage is lower than the output voltage VOUT, the inductor ID may be discharged by the ground voltage provided from the input node Nin. Accordingly, in the second discharging step Q3, the inductor current I_L may decrease due to a change in the voltage of the inductor ID.

Accordingly, when the second input voltage VIN2 is less than the output voltage VOUT provided to the output node Nout, the inductor ID may operate in the first charging step Q1 by turning on the first transistor P1, the first discharging step Q2 by turning on the second transistor P2, and the second discharging step Q3 by turning on the third transistor N1.

Moreover, the inductor ID may repeatedly operate in the first charging step Q1, the first discharging step Q2, and the second discharging step Q3.

FIG. 6B illustrates an operation of the IVR 111 when the second input voltage VIN2 provided to the input node Nin through the second transistor P2 is greater than the output voltage VOUT provided to the output node Nout.

When the second input voltage VIN2 is greater than the output voltage VOUT provided to the output node Nout, the inductor ID may operate in a first charging step Q1 by turning on the first transistor P1, a second charging step Q2 by turning on the second transistor P2, and a discharging step Q3 by turning on the third transistor N1. The first charging step Q1 of FIG. 6B may be similar to the first charging step Q1 of FIG. 6A, and the discharging step Q3 of FIG. 6B may be similar to the second discharging step Q3 of FIG. 6A. Additional descriptions of the first charging step Q1 and the discharging step Q3 of FIG. 6B may be omitted to avoid redundancy.

In the second charging step Q2, the controller CTL may output the second control signal SP2 having a low level, the first control signal SP1 having a high level, and the third control signal SN1 having a low level. When the second control signal SP2 having a low level is provided to the gate node of the second transistor P2, the second transistor P2 is turned on, and the second input voltage VIN2 may be provided to the input node Nin. The first control signal SP1 which has a high level and the third control signal SN1 which has a low level are provided to the gate nodes of the first transistor P1 and the third transistor N1, respectively, and the first transistor P1 and the third transistor N1 may be turned off. Therefore, as a result, only the second input voltage VIN2 may be provided to the input node Nin. The inductor ID may be charged by the second input voltage VIN2 provided from the input node Nin. In the second charging step Q2, the inductor current I_L may increase due to a change in the voltage of the inductor ID.

The inductor ID may repeatedly operate in the first charging step Q1, the second charging step Q2, and the discharging step Q3.

In an embodiment, when the level of the second input voltage VIN2 provided to the input node Nin through the second transistor P2 is the same or actually the same as the level of the output voltage VOUT provided to the output node Nout, the IVR 111 may operate in a charging step, a neutral step, and a discharging step. The charging step and discharging step may correspond to steps Q1 and Q3 in FIGS. 6A and 6B, respectively. In the neutral step, the controller CTL may output the second control signal SP2 which has a low level, and the first control signal SP1 which has a high level and the third control signal SN1 which has a low level. When the second control signal SP2 having the high level is provided to the gate node of the second transistor P2, the second transistor P2 is turned on, and the second input voltage VIN2 may be provided to the input node Nin. Since the voltage of the inductor ID need not change in the neutral step, the inductor current I_L need not actually change.

FIGS. 6A and 6B illustrate that the IVR 111 of FIG. 5 according to an embodiment of the present disclosure operates in continuous current mode (CCM), however, unlike this, the IVR 111 may also operate in discontinuous current mode (DCM) by turning off all transistors P1, P2, and N1 for a specific interval of time between waveform periods.

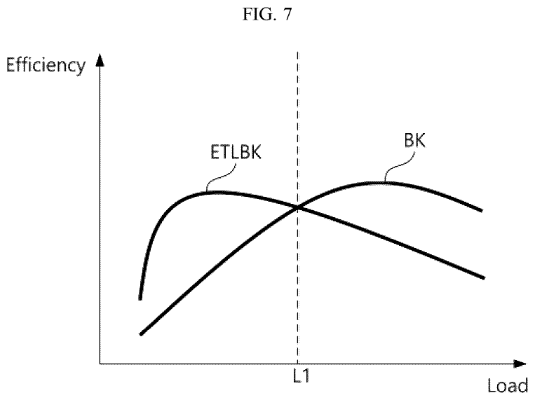

FIG. 7 shows a comparison of efficiencies for the ETLBK according to an embodiment of the present disclosure, versus an energy efficiency of a basic buck converter (BK) under various loads.

As described supra, the basic buck converter BK may be less energy efficient in a light load environment than in a heavy load environment, while the ETLBK may be more energy efficient in a light load environment than in a heavy load environment such as due to reduced switching losses at relatively light load versus flying capacitor losses at relatively heavy load. In a light load range environment, the loss of energy conversion

due to switching frequency is one of the main causes of energy loss. The IVR according to an embodiment of the present disclosure may maintain a low switching frequency like the ETLBK and thus achieve greater low energy efficiency than a basic buck converter in a light load range environment. In contrast, in a heavy load range environment, the loss of energy conversion due to the switching frequency is not a major factor in energy efficiency, so the IVR according to an embodiment of the present disclosure may have energy efficiency comparable to that of the basic buck converter BK of FIG. 7 in the heavy load range environment.

According to an embodiment, under heavy load conditions and specific physical characteristic conditions of inductors and switches composing the IVR according to an embodiment of the present disclosure, the energy efficiency of the IVR may be greater than the energy efficiency of the ETLBK. Conversely, under light load conditions and specific physical characteristic conditions of inductors and switches composing the IVR according to an embodiment of the present disclosure, the energy efficiency of the IVR according to an embodiment of the present disclosure may be greater than the energy efficiency of the basic buck converter BK.

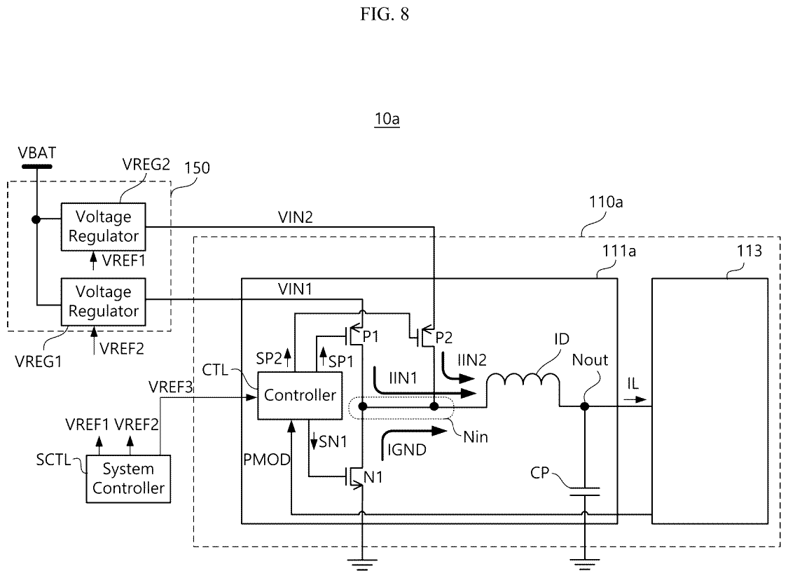

Accordingly, the IVR according to an embodiment of the present disclosure may operate in different modes depending on load conditions. This may be described in greater detail with reference to FIGS. 8 to 10.

FIGS. 8 and 9 show an IVR 111a and the external voltage regulators VREG1 and VREG2 included in an electronic device 10a according to an embodiment of the present disclosure. The IVR 111a may correspond to the IVR 111 described with reference to FIG. 5. The external voltage regulators VREG1 and VREG2 may be the same as the external voltage regulators VREG1 and VREG2 of FIG. 5. The IVR 111a according to an embodiment of the present disclosure will be described with reference to FIG. 8. Additional descriptions of parts similar to or overlapping with the IVR 111 of FIG. 5 may be omitted to avoid redundancy.

Referring to FIGS. 8 and 9, a semiconductor IC chip 110a according to an embodiment of the present disclosure may include the IVR 111a and the load circuit 113.

The IVR 111a may receive mode information from the load circuit 113. The mode information may be a command instructing the IVR 111a to operate in one of a plurality of modes. For example, the mode information may be a command instructing the IVR 111a to operate in a mode corresponding to a heavy load of the load circuit 113 or a mode corresponding to a light load of the load circuit 113. For example, a first mode may be a mode in which the first switch P1 (i.e., the first transistor P1), the second switch P2 (i.e., the second transistor P2), and the third switch N1 (i.e., the third transistor N1) are operated in response to a light load of the load circuit 113. In greater detail, the first mode may be a mode in which the IVR 111a generates the output voltage based on the first input voltage VIN1, the second input voltage VIN2, and the ground voltage provided from the external voltage regulators VREG1 and VREG2, and provides the load current IL based on the output voltage to the load circuit. The second mode may be a mode in which the operation of the second switch P2 is stopped, and the first switch P1 and the third switch N1 are operated in response to the heavy load of the load circuit 113. In greater detail, the first mode may be a mode in which the IVR 111a generates the output voltage based on the first input voltage VIN1 provided from the external voltage regulator VREG1 and the ground voltage, and provides the load current IL based on the output voltage to the load circuit 113.

FIG. 8 illustrates the IVR 111a operating in the first mode.

The controller CTL of the IVR 111a may receive mode information PMOD instructing the IVR 111a to operate in the first mode in response to a light load of the load circuit 113, and may generate the control signals SP1, SP2, and SN1. The control signals SP1, SP2, and SN1 are provided to the gate nodes of the first switch P1, the second switch P2, and the third switch N1, respectively, and the first switch P1, the second switch P2, and the third switch N1 may be sequentially turned on in a complementary manner. Therefore, as described with reference to FIGS. 5 and 6, through the inductor ID, an inductor current IIN1 based on the first input voltage VIN1 may flow by the turn-on of the first switch P1, an inductor current IIN2 based on the second input voltage VIN2 may flow by the turn-on of the second switch P2, and an inductor current IGND based on the ground voltage may flow by the turn-on of the third switch N1, in sequence. In greater detail, the IVR 111a may operate as illustrated in the operation diagram of FIG. 6. Therefore, as described with reference to FIG. 6, the IVR 111a may reduce the switching frequency by turning on the second switch P2 and may increase the energy conversion efficiency of the IVR 111a under a light load.

FIG. 9 illustrates the IVR 111a operating in the second mode.

The controller CTL of the IVR 111a may receive the mode information PMOD instructing the IVR 111a to operate in the second mode in response to a heavy load of the load circuit 113, and may generate the control signals SP1, SP2, and SN1. The control signals SP1, SP2, and SN1 are provided to the gate nodes of the first switch P1, the second switch P2, and the third switch N1, respectively, and the first switch P1, the second switch P2, and the third switch N1 may be sequentially turned on in a complementary manner.

Unlike the first mode in FIG. 8, the second switch control signal SP2 continues to maintain a low level in the second mode, and thus the second switch P2 may maintain a turn-off state. In greater detail, the IVR 111a may stop the operation of the second switch P2. Accordingly, through the inductor ID, the inductor current IIN1 based on the first input voltage VIN1 may flow by the turn-on of the first switch P1, and the inductor current IGND based on the ground voltage may flow by the turn-on of the third switch N1, in sequence. In greater detail, the inductor current IIN2 capable of being generated when the second switch P2 is turned on does not flow through the inductor ID.

FIG. 10 shows the operation of the IVR 111a in the second mode.

The second transistor P2 of the IVR 111a may be maintained in a turned-off state, and the first transistor P1 and third transistor N1 may be sequentially turned on in different time intervals. Referring to FIG. 10, in the Q1 step between times T0 and T1, only the first transistor P1 may be turned on, and the second transistor P2 and the third transistor N1 may be turned off. After the Q1 step, in the Q2 step between times T1 and T2, only the third transistor N1 may be turned on, and the first transistor P1 and the second transistor P2 may be turned off. Thereafter, the IVR 111a may operate to repeat steps Q1 and Q2. In greater detail, the Q1 step and the Q2 step form one period. Accordingly, in the second mode, the IVR 111a may stop the operation of the second switch P2 and may operate similarly to a basic buck converter BK. Accordingly, the IVR 111a may maintain the energy conversion efficiency of the IVR 111a even under specific conditions.

The IVR 111a described with reference to FIGS. 8 and 9 may allow the controller CTL to maintain the second switch control signal SP2 at a high level based on the mode information PMOD, so that the IVR 111a may further operate similarly to a basic buck converter BK. In greater detail, unlike the buck converter described in FIG. 4A, the IVR 111a according to an embodiment of the present disclosure may operate in a mode with high energy efficiency in a light load environment and a heavy load environment only by changing the control signal. In contrast, the related technology of FIG. 4A uses the flying capacitor, so the embodiments of the present disclosure need not operate similarly to a basic buck converter in a heavy load environment such as by changing the control signal. Additionally, the electronic device 10a according to an embodiment of the present disclosure does not use the flying capacitor, so the electronic device 10a may occupy a small area despite high energy efficiency in a light load environment. As a result, the IVR 111a according to an embodiment of the present disclosure may be used as the IVR of a semiconductor device.

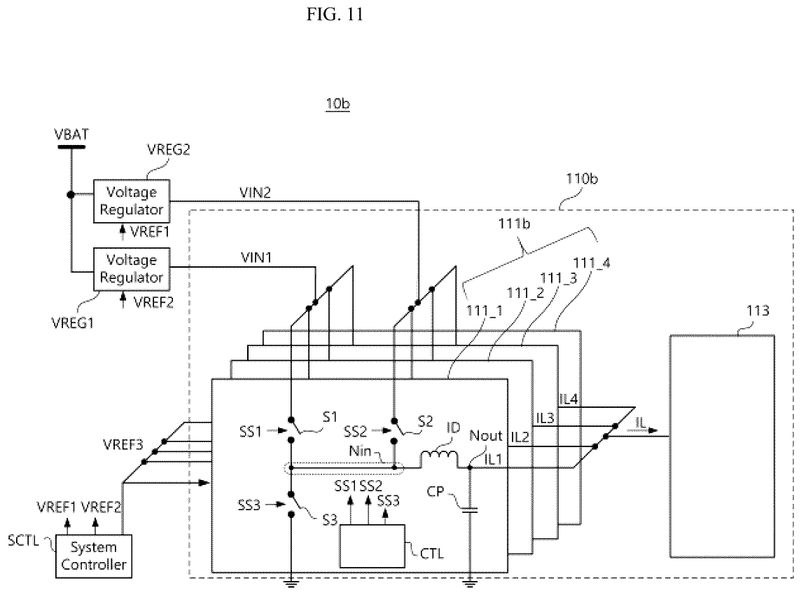

FIG. 11 shows an IVR 111b and the external voltage regulators VREG1 and VREG2, which are included in an electronic device 10b, according to an embodiment of the present disclosure. The electronic device 10b of FIG. 11 may correspond to the electronic device 10 of FIG. 1, and the IVR 111b may correspond to the IVR 111a of FIG. 5. Additional descriptions of parts similar to or overlapping with the description referring to FIGS. 1 and 5 may be omitted to avoid redundancy.

The IVR 111b according to an embodiment of the present disclosure may be composed of a plurality of IVRs sharing one capacitor CP. For example, referring to FIG. 11, the IVR 111b may be composed of four IVRs 111_1, 111_2, 111_3, and 111_4. The number of IVRs 111_1, 111_2, 111_3, and 111_4 is only an example, and the embodiment of the present disclosure is not limited to four IVRs 111_1, 111_2, 111_3, and 111_4.

Each of the IVRs 111_1, 111_2, 111_3, and 111_4 may operate as illustrated in the operation diagram of FIG. 6A or FIG. 6B. Alternatively, each of the IVRs 111_1, 111_2, 111_3, and 111_4 may operate in a charging step, a neutral step, and a discharging step. In greater detail, each of the IVRs 111_1, 111_2, 111_3, and 111_4 may operate in three operation steps.

The IVRs 111_1, 111_2, 111_3, and 111_4 may generate inductor currents IL1, IL2, IL3, and IL4, respectively, according to waveforms of different steps. The load current IL which is the sum of the inductor currents IL1, IL2, IL3, and IL4 may be provided to the load circuit.

The inductor currents IL1, IL2, IL3, and IL4 according to waveforms of different phases, which are generated by the IVRs 111_1, 111_2, 111_3, and 111_4, respectively, may have waveforms, the phases of which are shifted by, for example, 0 degree, 90 degrees, 180 degrees, and 270 degrees, respectively, without limitation thereto. The controller CTL of each of the IVRs 111_1, 111_2, 111_3, and 111_4 may generate control signals SS1, SS2, and SS3 for controlling the plurality of switches S1, S2, and S3 based on the switching timing of the phases to generate a phase-shifted waveform.

As described with reference to FIG. 5, each of the IVRs 111_1, 111_2, 111_3, and 111_4 does not include a flying capacitor. Therefore, despite providing a high load current IL to the load circuit using the plurality of IVRs 111_1, 111_2, 111_3, and 111_4, the IVR 111b does not occupy a large area. Therefore, the IVR 111b according to an embodiment of the present disclosure may be used as the IVR of a semiconductor device.

In addition, each of the controllers CTL of the IVRs 111_1, 111_2,

111_3, 111_4 may minimize an output ripple voltage by controlling the plurality of switches S1, S2, and S3 based on the switching timing of phases to generate a phase-shifted waveform, to support interleaving operations for each phase. In addition, the number of phases of the inductor currents IL1, IL2, IL3, and IL4 generated by each of the IVRs 111_1, 111_2, 111_3, and 111_4 may be controlled depending on the amount of the load current required by the load circuit.

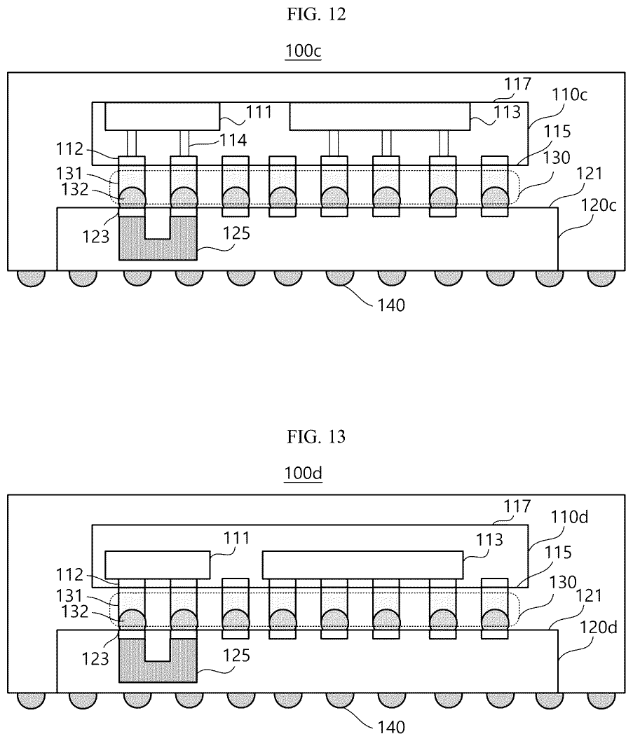

FIG. 12 shows an example of a semiconductor device 100c, according to an embodiment of the present disclosure. The semiconductor device 100c may correspond to the semiconductor device 100 of FIG. 1.

Additional descriptions of parts similar to or overlapping with the semiconductor device 100 described with reference to FIG. 3 may be omitted to avoid redundancy.

The semiconductor device 100c according to an embodiment of the present disclosure may be a semiconductor device packaged after a semiconductor IC chip 110c that is connected to a substrate 120c through the electrical paths 130. The substrate 120c may be a packaging substrate.

In an embodiment, the semiconductor IC chip 110c may include functional blocks such as the IVR 111 and the load circuit 113, which are formed in an active area of a lower surface 117. The IVR 111 and the load circuit 113 may be connected to the electrical paths 130 through the conductive contacts 112 located on the top surface 115 through a through silicon electrodes 114 inside the semiconductor IC chip 110c. The electrical paths, such as metal layers, may be formed inside the semiconductor IC chip 110c.

In an embodiment, the substrate 120c may include an embedded inductor 125 to provide an inductance or an additional inductance to the IVR 111 of the semiconductor IC chip 110c. The embedded inductor 125 may provide the inductance or the additional inductance to the IVR 111 through the conductive contact 123 of the substrate 120c, the electrical path 130, the conductive contact 112 of the semiconductor IC chip 110c, and the through silicon electrode 114. Accordingly, the semiconductor device 100b according to an embodiment of the present disclosure may complement the on-chip inductor of the semiconductor IC chip 110c.

FIG. 13 shows an example of a semiconductor device 100d, according to an embodiment of the present disclosure. The semiconductor device 100d may correspond to the semiconductor device 100 of FIG. 1. Additional descriptions of parts similar to or overlapping with the semiconductor device 100c described with reference to FIG. 12 may be omitted to avoid redundancy.

The semiconductor IC chip 110d of the semiconductor device 100d according to an embodiment of the present disclosure may include functional blocks such as the IVR 111 and the load circuit 113 formed in an active area of the top surface 115. The electrical paths, such as metal layers, may be formed inside the semiconductor IC chip 110d.

In an embodiment, the substrate 120d may include the embedded inductor 125 to provide an inductance or an additional inductance to the IVR 111 of the semiconductor IC chip 110d. The embedded inductor 125 may provide the inductance or the additional inductance to the IVR 111 through the conductive contacts 123 of the substrate 120d, the electrical paths 130, and the conductive contacts 112 of the semiconductor IC chip 110d. Accordingly, the semiconductor device 100d according to an embodiment of the present disclosure may complement the on-chip inductor of the semiconductor IC chip 110d.

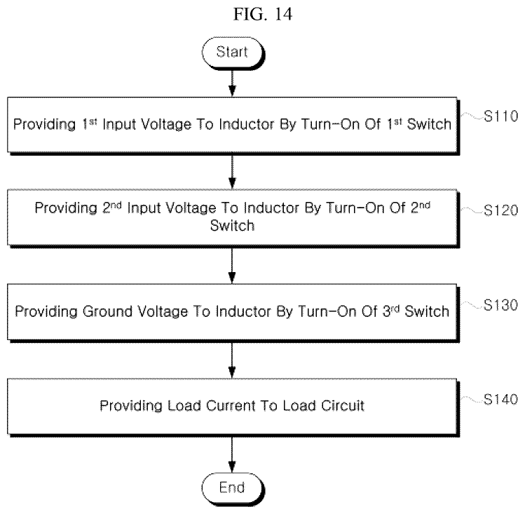

FIG. 14 shows a method of operating an IVR, according to an embodiment of the present disclosure. The operation method of the IVR may be performed in the IVR 111 described with reference to FIGS. 1 and 5. Additional descriptions of parts that are similar to or overlap with the operation of the IVR 111 described with reference to FIGS. 1 to 6B may be omitted to avoid redundancy.

In operation S110, the IVR 111 may turn on the first switch inside the IVR 111 and may provide the first input voltage provided from a voltage regulator outside the IVR 111 to the inductor ID during a specific interval of time. The second and third switches respectively connected to the second input voltage and the ground voltage may be turned off.

In operation S120, the IVR 111 may turn on the second switch inside the IVR 111 and may provide the second input voltage provided from a voltage regulator outside the IVR 111 to the inductor ID during a specific interval of time. The first and third switches respectively connected to the first input voltage and the ground voltage may be turned off.

In operation S130, the IVR 111 may turn on the third switch inside the IVR 111 and may provide the ground voltage to the inductor ID during a specific interval of time. The first and second switches respectively connected to the first input voltage and the second input voltage may be turned off.

In operation S140, the inductor ID may provide the load current to the load circuit through the output node. The load current may be a load current generated in each of operations S110, S120, and S130. The operation S140 may be performed together with operations S110, S120 and S130.

The operations S110 to S140 may be repeated. The output node may be connected to a ground through a capacitor.

According to an embodiment of the present disclosure, the IVR may achieve high energy efficiency while having a small area. As a result, the energy efficiency of the semiconductor device including the IVR may be increased.

According to an embodiment of the present disclosure, the IVR may achieve high energy efficiency at soft and/or light loads. As a result, energy efficiency may be increased in various load environments of the semiconductor device including the IVR.

The above descriptions are of illustrative examples for carrying out embodiments of the present disclosure. Embodiments in which a design is changed simply or which are easily changed are to be included in the scope of the present disclosure, without limitation. In addition, technological details that are easily changed and implemented based the above description remain within the scope of the present disclosure. Therefore, the scope of the present disclosure shall not be limited to the above-described examples, and should be defined by not only the claims to be described infra, but also by those equivalents to the claims of the present disclosure as may be practiced by those of ordinary skill in the pertinent art based on the teachings of the present disclosure.

What is claimed is:

1. A semiconductor device comprising:
a voltage regulator;
a semiconductor integrated circuit (IC) chip including a load circuit configured to receive a load current from the voltage regulator; and
a substrate including an electrical path configured to provide a signal to at least one of the voltage regulator or the semiconductor IC chip,
wherein the voltage regulator includes:
a capacitor including one end connected to an output node and the other end connected to a ground;
an inductor connecting the output node to an input node; and
a first switch, a second switch, and a third switch, one end of each switch respectively connected to the input node,
wherein the first switch, the second switch, and the third switch alternately provide a first input voltage, a second input voltage, and a ground voltage to the input node, respectively.

2. The semiconductor device of claim 1,
wherein the substrate includes at least a portion of the inductor,
wherein the voltage regulator is an integrated voltage regulator integrated into the semiconductor IC.

3. The semiconductor device of claim 1, wherein the first switch, the second switch, and the third switch are sequentially turned on at different time intervals, when any one of the first switch, the second switch, and the third switch is turned on, the remaining switches are turned off.

4. The semiconductor device of claim 3, wherein the second switch is turned on for a longer time interval than the first switch.

5. The semiconductor device of claim 3,
wherein the first switch provides the first input voltage to the input node by turning on, the second switch provides the second input voltage to the input node by turning on, and the third switch provides the ground voltage to the input node by turning on,
wherein the first input voltage is greater than an output voltage of the output node, and the second input voltage is greater than, less than, or equal to the output voltage.

6. The semiconductor device of claim 1, wherein the first input voltage is greater than the second input voltage.

7. The semiconductor device of claim 5, wherein the inductor operates in a first charging step by turning on the first switch, in a second charging step by turning on the second switch, in a discharging step by turning on the third switch, and in the second charging step after the first charging step.

8. The semiconductor device of claim 5, wherein the inductor operates in a charging step by turning on the first switch, in a first discharging step by turning on the second switch, in a second discharging step by turning on the third switch, and in a second discharging step after the first discharging step.

9. The semiconductor device of claim 1,
wherein the voltage regulator is composed of a plurality of voltage regulators sharing one capacitor,
wherein each of the plurality of voltage regulators generates load currents having different phases.

10. The semiconductor device of claim 1, further comprising:
a controller configured to generate switch driving signals which respectively control the first switch, the second switch, and the third switch, wherein the controller stops or operates the second switch based on a mode control signal.

11. The semiconductor device of claim 10, wherein the controller operates the second switch in response to a first mode indicated by the mode control signal and stops an operation of the second switch in response to a second mode indicated by the mode control signal.

12. The semiconductor device of claim 1,
wherein the voltage regulator further includes a controller configured to generate switch driving signals which respectively control the first switch, the second switch, and the third switch,
wherein the controller controls a time interval in which the second switch is turned on based on a target voltage to be provided to the output node.

13. An electronic device comprising:
a power management device including a first voltage regulator configured to receive a battery voltage and to generate a first input voltage which is regulated and a second voltage regulator configured to receive the battery voltage and to generate a second input voltage which is regulated; and
a system-on-chip (SOC) including an integrated voltage regulator (IVR) configured to generate a load current based on the first input voltage and the second input voltage, and a load circuit configured to receive the load current through an output node,
wherein the IVR includes:
a plurality of switches configured to alternately provide the first input voltage, the second input voltage, and a ground voltage to an inductor;
the inductor configured to alternately receive the first input voltage, the second input voltage, and the ground voltage, and to provide the load current to the output node; and
a capacitor configured to connect the output node to a ground.

14. The electronic device of claim 13, wherein the first voltage regulator and the second voltage regulator generate the first input voltage and the second input voltage, respectively, based on the battery voltage and the ground voltage.

15. The electronic device of claim 14,
wherein the first voltage regulator includes a first inductor, and the second voltage regulator includes a second inductor,
wherein the first inductor and the second inductor operate in two steps, and the inductor operates in three steps.

16. The electronic device of claim 15,
wherein the first inductor and the second inductor operate in a charging step and a discharging step,
wherein the inductor:
operates in a first charging step, a second charging step, and a discharging step,
operates in a charging step, a first discharging step, and a second discharging step, or
operates in a charging step, a neutral step, and a discharging step.

17. The electronic device of claim 13,
wherein the plurality of switches include a first switch, a second switch, and a third switch,
wherein the first switch, the second switch, and the third switch are sequentially turned on at different time intervals, when any one of the first switch, the second switch, and the third switch is turned on, the remaining switches are turned off.

18. The electronic device of claim 17, wherein the first input voltage is greater than the second input voltage.

19. A method of operating a voltage regulator, the method comprising:
providing a first input voltage received from outside of the voltage regulator to an inductor by turning on a first switch inside the voltage regulator;
providing a second input voltage, which has a different level from the first input voltage and is received from outside of the voltage regulator, to the inductor by turning on a second switch inside the voltage regulator;
providing a ground voltage to the inductor by turning on a third switch inside the voltage regulator; and
providing, by the inductor, a load current to a load circuit through an output node,
wherein the output node is connected to a ground through a capacitor.

20. The method of claim 19,
wherein the first input voltage is greater than the second input voltage,
wherein the first input voltage is greater than an output voltage of the output node,
wherein the second input voltage is greater than, less than, or equal to the output voltage,
wherein the voltage regulator is an integrated voltage regulator integrated into a semiconductor integrated circuit (IC).
